(19) United States
(12) Patent Application Publication
(10) Pub. No.: US 2008/0163964 A1
(43) Pub. Date: Jul. 10, 2008

(54) PROTECTIVE COVER FOR WALLET CARD AND METHOD

(76) Inventor: JAMES K. BRANNON, Leawood, KS (US)

Correspondence Address: Arthur Shaffer;Intellectual Property Center, LLC, Suite 100, 9233 Ward Parkway, Kansas City, MO, 64114, US

(21) Appl. No.: 11/970,246

(22) Filed: Jan. 7, 2008

Related U.S. Application Data
(60) Provisional application No. 60/878,865, filed on Jan. 5, 2007.

(51) Int. Cl. A45C 11/18; G06K 19/00

(52) U.S. Cl. 150/147; 235/487

(57) ABSTRACT

The present invention provides a wallet card holder device adapted for receiving a wallet card having an identifier and an encoded strip, the wallet card identifier being partially covered by said device, said encoded strip remaining uncovered, the device including a front panel spaced from a rear panel and being generally associated with the wallet card, the front panel having a configuration and an engaging member associated with the identifier, said engaging member limiting movement of the wallet card received within the wallet card holder device, the rear panel positioned below the encoded strip and a lower biasing structure adapted for positioning the identifier within the configuration.

### CROSS-REFERENCE TO RELATED APPLICATION

This application claims the benefit of the prior filed. U.S. provisional application No. 60/878,865 filed Jan. 5, 2007 which is incorporated herein by reference.

### FIELD OF THE INVENTION

The present invention relates generally to wallet card holders and more particularly to an improved device and method for a wallet card holder having a wallet card with embossed members such as numbers or letters, the device having a concealing surface for at least partial protection of the confidential information contained on the wallet card.

### BACKGROUND OF THE INVENTION

The use of wallet cards such as credit, debit, bank, rental and telephone cards is commonplace among persons involved in all types of financial transactions. Wallet cards are typically uniform in size, shape and configuration. Each card is typically issued with an identification number assigned to the card owner. The identification number is typically printed or embossed in the central section of the front side of the card and a magnetically encoded strip along with a signature area is typically positioned on the reverse side, often opposite the number. Other confidential information may be located on the card front or rear at various positions. The confidential information is used to facilitate a consumer purchase transaction.

Identity theft is a growing problem for consumers and financial institutions, with over 250,000 complaints filed in 2005. 3.6 million U.S. households became victims in 2004 and it has been reported that someone's identity is stolen every 79 seconds with average arrest rates for identity theft victims being less than 5% of ail reported cases. Inadvertent disclosure and acquisition of the confidential information may also be used to readily initiate a fraudulent purchasing transaction involving items ranging from a few dollars to tens of thousands of dollars. Credit Card industry newsletters have reported that losses due to fraudulent uses of credit cards are $1.1 billion with approximately $6.4 billion in identity theft losses annually. It would therefore be beneficial to provide a method and apparatus to protect the confidential information of a wallet card while providing a way to readily verify the identity of the card or cardholder.

Many wallet cards use a long series of numbers as the personal account number to help uniquely identify the wallet card, in a valid card these numbers will match the numbers on the encoded magnetic stripe located on the rear of the card. Without specialized equipment, the card holder can not read the information contained on the rear of the card and memorizing a long series of numbers is difficult, while memorizing a shorter list is usually easier. Some of the personal account information located on the front is unique, while other information is not unique. While there have been some devices which cover at least a portion of the wallet card, some of these do not distinguish between the different types of data present on the wallet card. Some data is confidential, while other data is non-confidential. Some data is unique, while other data is not. Therefore, it would be beneficial to have a device and method for protecting the confidential information associated with a wallet card.

Some cards present the personal account information on the front of the card, with similar information being located on the encoded magnetic strip which is adapted for being read by a card reader used by a merchant during a purchase transaction for identifying the card holder, the card holder account and the issuing financial institution. The visible information is generally too long to easily remember. However, by limiting the visible information to a simple string of numbers associated with the card, it may be possible to easily verify the identity of the card within the protective card cover, while protecting the personal account information and other confidential data. If the limited, string of information is obtained, it would be of limited value in duplicating or accessing the credit card account or in connection with some other fraudulent activity. It therefore would be beneficial to provide a device which protected the confidential information of a wallet card, including the personal account information, permitting access to a subset of the personal account information for ready verification of the wallet card contained within the wallet card holding device, while protecting confidential data.

During a consumer purchase transaction, the card may need to he removed from a wallet or other device and handed to a seller for processing the consumer transaction. During the purchase transaction, the seller may swipe a magnetic strip located on the back of the card and enters a validation code such as a pin, expiration date or other confidential information. However, while the card is out of the consumer's possession, the confidential information contained on the credit card is at risk. While, the use of magnetic card readers may facilitate a purchase transaction without the need for the retailer to visually identity the embossed account number on the card surface, the consumer would need to verify the identity of the returned card. Therefore it would be beneficial to provide a protective cover for the wallet card which continues to protect the card while out of the control of the card holder, and permits the seller to swipe the encoded, strip through a card reader.

During the time the card is out of the purchaser's control, the card's confidential information may be exposed, displayed or acquired by unauthorized card, users. Wallet cards may have confidential information such as a name, number or other confidential information such as expiration date. During use, wallet cards may be openly displayed on a horizontal surface in crowded public spaces, such as bars, restaurants, cocktail lounges, airports, hotels, fast food establishments, coffee shops, and other consumer and retail outlets. Because of the public display of the credit card information, it is possible that nearby persons may observe and acquire the confidential information including the name, expiration data and credit card number of the displayed wallet card. In addition, because more purchase transaction are frequently conducted with paperless wallet cards, some card holders pay less attention to the transaction and to their card during and after the transaction. It would therefore be beneficial, to provide a method and device which allow for ready verification of the identity of the wallet card at the conclusion of the purchase transaction, ensuring that the wallet card used during the transaction is returned at its conclusion.

Some known devices may provide a sheath or other protective cover which completely surrounds the entire credit card. Use of this device, requires that the card be removed in order to finish the consumer transaction. Another device may provide a protective cover over the credit card while providing access to the card's rear encoded strip. However, these devices while covering the confidential information, limit the ability of the consumer to verify the identity of the returned card. In this way, the cover or sheath may be opened and the card may be removed and replaced with another card or removed altogether, without the card holder's knowledge. In such case, the consumer may only become aware of the removal at a later time, while the consumer may be liable for fraudulent use of the card during the intervening period.

In addition, in some situations, displaying a card during a consumer transaction may communicate a message from the consumer to others. In some cases, the card may be a gold or platinum card which may indicate some character about the consumer. In other cases, the card may be a lower end debit card which may indicate something else. During the time the card, is used in some consumer transactions, it is placed, upon a table or other public space and viewed by others who are nearby with some degree of evaluation of the character or quality of the consumer. However, the cards are typically preprinted by the bank or other financial institution with its logo or other indicia which is often preprinted and impersonal. While some cards allow for limited personalization, typically the ability to personalize the card is limited in part because the card may be governed by certain regulations which specify the size and shape of the card. It therefore would be beneficial to provide a method and device for protection of the confidential information of a wallet card while providing for the personalization of the card for displaying emblems or visual indicia based on a consumer or advertising preferences.

Some sources indicate that 85 percent of all identity theft victims find out about a crime only after the crime has occurred. It therefore would be beneficial to provide a device and methods for protecting the confidential information located on the credit card, while allowing the consumer to readily access and verity the card's identity using a portion of the confidential information deterring use of the card in a fraudulent or criminal activity.

### SUMMARY OF THE INVENTION

A wallet card holder device adapted for receiving a wallet card having an identifier and an encoded strip, the wallet card identifier being partially covered by said device, said encoded strip remaining uncovered, the device including a front panel associated with the wallet card and having an engaging member associated with the identifier, limiting vertical movement of the card received within said device, a rear panel spaced from said front panel and below the encoded strip, said front panel having a configuration for displaying a portion of the identifier and a lower biasing structure adapted for positioning said identifier within said configuration said wallet card extending longitudinally from said lower biasing structure along said front panel and outwardly from said holder whereby said encoded strip is accessible.

### BRIEF DESCRIPTION OF THE DRAWINGS

The drawings constitute a part of this invention and include exemplary embodiments of the present invention and illustrate various objects and features thereof.

FIG. 1 is an orthogonal view of a wallet card holding device in receipt of a wallet card in accordance with the present invention.

FIG. 2 is a cross-sectional view of the wallet card holding device at the side rail in accordance with the invention of FIG. 1.

FIG. 3 is a front elevational view of the wallet card holding device in receipt of the wallet card the embodiment of FIG. 1.

FIG. 4 is a side cross-sectional view of the wallet card holding device in receipt of the wallet card in accordance with the invention of FIG. 1.

FIG. 5 is an orthogonal view of an alternative embodiment of the present invention n receipt of a wallet card.

FIG. 6 is a side cross-sectional view of the alternative embodiment of FIG. 5 in receipt of the wallet card.

FIG. 7 is a side cross-sectional view of the alternative embodiment of FIG. 5 without the wallet card.

FIG. 8 is a magnified partial cross-sectional side view of a lower biasing section.

FIG. 9 is an orthogonal view of an alternative embodiment of the present invention without the wallet card in accordance with the alternative embodiment of FIG. 5.

FIG. 10 is a front elevational view of an alternative embodiment of the present invention with panels having a frustoconical configuration and a visual indicia in association with the wallet card holder in accordance with an alternative aspect of the present invention.

FIG. 11 is a front elevational view of the alternative embodiment of FIG. 10 having an identifying element corresponding to additional indicia associated with the wallet card.

FIG. 12 is a front elevational view of an alternative aspect of the embodiment of FIG. 10 having panels with an alternative frustoconical configuration.

FIG. 13 is a front elevational view of an alternative embodiment of the present invention having an alignment structure.

FIG. 14 is an exploded view of the embodiment of FIG. 13.

FIG. 15 is a front elevational view of a wallet card having an alternative alignment receiver in accordance with an alternative aspect of the embodiment of FIG. 13.

### DETAILED DESCRIPTION

### I. Introduction.

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

### II. Wallet Card Holding Device.

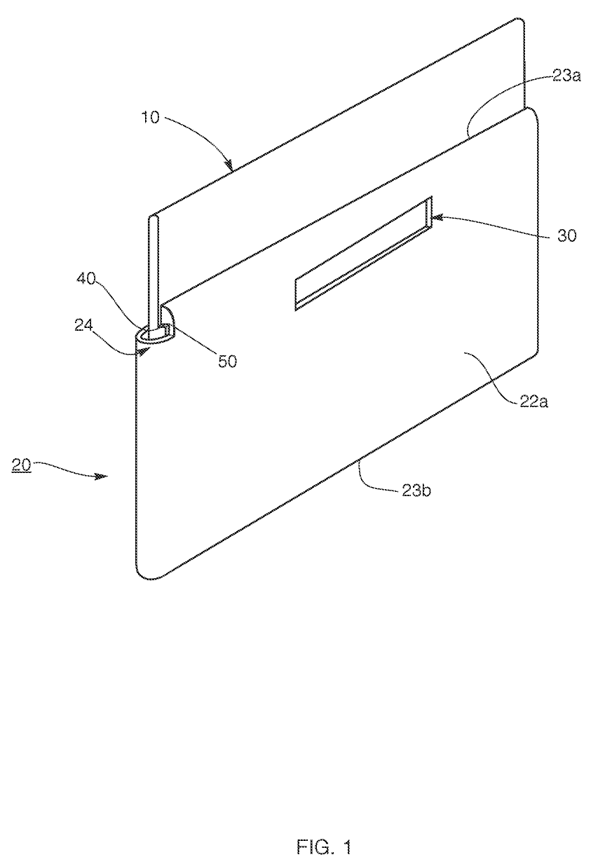

Referring to FIG. 1, in one aspect of the present invention a combination wallet card holding device (also referred to herein as device) in combination with a wallet card is generally indicated, by reference numeral 20, the device being in general receipt of the typical wallet card. 10 such as but not limited to a credit, debit, bank or other financial institution cards. The device 20 having a front panel 22a and a rear panel 22b spaced apart by at least one side rail 24 is illustrated in FIG. 1 in which the panels 22a, 22b generally terminate at a bottom 23b, which extends laterally across front and rear panel 22a, 22b edges and define a card, receiver 26 adapted to receive the wallet card. 10. The front and rear panels 22a, 22b may optionally be configured for placement within a standard compartment of a wallet (not shown), the panels 22a, 22b spaced apart by side rail 24 having sufficient dimensions to receive a typical wallet card 10.

The front panel 22a having a configuration 30 is also illustrated in FIG. 1. The configuration 30 provides access to a portion of the received wallet card 10 for verification of the cards identity. The wallet card 10 may include an identifier 12 such as an account number or other unique identifier associated with the card holder which extends across the front surface of the wallet card 10, at least a portion of which is positioned near the configuration 30 associated with the front panel 22a. The rear panel 22b is generally associated with the encoded magnetic strip located on the rear surface of the wallet card 10.

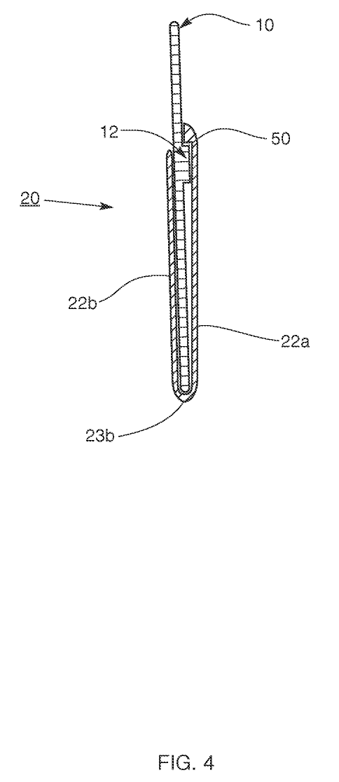

In operation, the wallet card holding device 20 is provided having the wallet card 10 positioned within the card receiver 26, the wallet card holding device 20 configured for displaying at least a portion of the identifier 12 which is applied to the wallet card 10, the wallet card being positioned within the wallet card holding device 20 for displaying a portion of the identifier 12 and covering a portion of the identifier 12 while a substantial portion of the encoded strip (not shown) remains uncovered. In general, the wallet card 10 is secured within the wallet card holding device 20 by an engaging member 40. The engaging member 40 may utilize mechanical, magnetic, adhesive or frictional means, but as illustrated in the embodiment of FIG. 4 may include a lateral supporting structure for supporting the wallet card in an upright manner and a notch 50 for receiving a raised surface extending outwardly from the wallet card 10 which may be associated, with the identifier 12 which may be a plurality of embossed characters by way of example and not as a limitation. In general, the notch 50 provides a channel for receiving the identifier 12 as the card extends laterally along the width of the front and rear panels 22a, 22b. While the engaging member 40 is illustrated with a frustopyamidal configuration for engaging the surface of the wallet card 10, alternatively known configurations may be utilized for engaging the surface of the wallet card 10 and supporting it in an upright manner.

During a purchase transaction in a crowded public space, for example, but not as a limitation, a bar, restaurant, or airport the wallet card holding device 20 maybe displayed in association with a horizontal surface such as counter top, table or bar the wallet card 10 extends outwardly from the card receiver 26, the bottom of the card 10 being generally positioned near the bottom 23b. While the card 10 is received by the card receiver 26, at least a portion of the identifiers 12 are visible within the configuration 30. The engaging member 40 may be used to secure the wallet card 10 within the card receiver 26 and may be positioned near a top 23a associated with the front panel 22a. While the engaging member 40 is illustrated near the top 23a of the wallet card holding device 10, it may also be positioned near the sidewalls 24 or the bottom 23b. The engaging surface 40 allows the wallet card 10 (also referred to herein as card) to be securely stored within the card receiver 26, the engaging member 40 generally being releasable in that the card may be removed if required. In addition, the front panel 22a may be configured, with the encoded strip associated with the rear surface of the wallet card 10, extending upwardly from the wallet card holder 20, for swiping the wallet card 10 through a card reader while the wallet card 10 is positioned, within the card receiver 26. In this configuration, the wallet card 10 may be utilized within the consumer transaction without removing the wallet card 10 from the wallet card holding device 20, without interference from the wallet card holder device 20 including its front panel 22a, while protecting the confidential information contained on the wallet card 10.

While the card is generally received by the card receiver 26, the card 10 may be positioned between the pair of side rails 24, sandwiched between the front and rear panels 22a, 22b. For the duration of most consumer transactions, this arrangement will provide protection of the confidential information. The engaging member 40 may provide additional security for maintaining the card 10 within the wallet card holding device 20 including, but not limited to frictional, adhesive or mechanical means, like the engaging member 40 illustrated in FIG. 4 with a bossed portion having a frustropyramidal configuration presenting a notch 50 for engaging the wallet card 10. The notch 50 is generally adapted to receive a raised section such as plural embossed identifiers 12 extending laterally across the surface of the wallet card 10. The notch 50 which is extends rearwardly from the front panel 22a and laterally along the wallet card holder 10, may help secure the wallet card 10 within the card receiver 26, the identifiers being generally aligned within the provided configuration 30 for ready verification of the received wallet card 10.

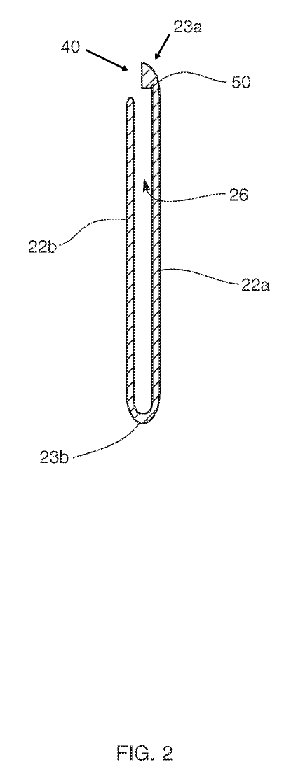

The wallet card 10 is absent from the card receiver 26 as illustrated in FIG. 2, the card receiver 26 spans the front and rear panels 22a, 22b, extending vertically from and laterally along the bottom 23b, terminating at the top 23a. The card receiver 26 is generally adapted to receive the wallet card 10. The notch 50 is also illustrated in FIG. 2 being generally associated with the engaging surface 40 near the top 23a.

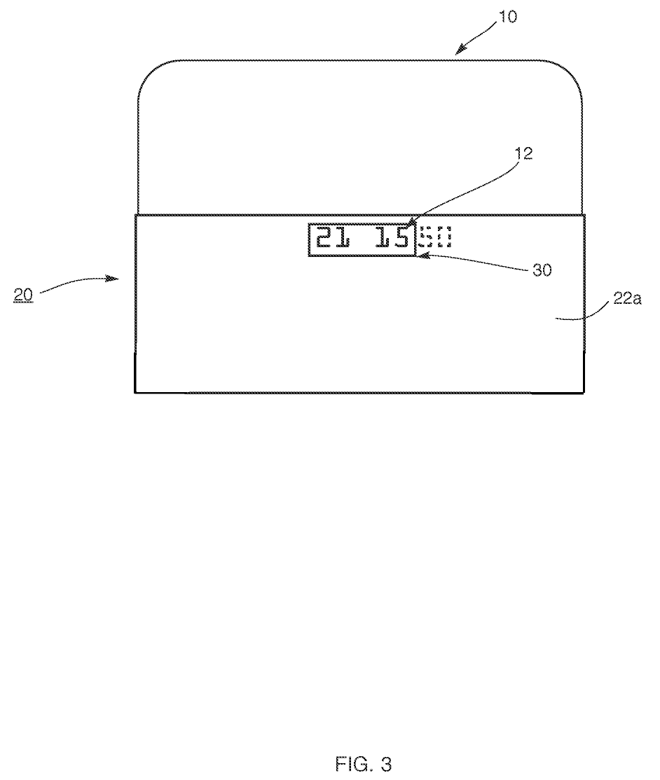

The front panel 22a illustrated in FIG. 3 includes a configuration 30 for displaying at least a portion of the confidential information or identifier 12. The configuration 30 is illustrated, in FIG. 3 has a generally rectangular orientation for displaying a portion of the identifier 12 also referred to herein as confidential information while covering the remaining portions of the identifier 12 with the front panel 22a. Because the identifier 12 is generally a unique sequence of characters associated with an account number, credit card number or bank account, by displaying only a limited number of characters the integrity of the confidential information is protected while the card holder may verify the identity of the wallet card 10, stored within the wallet card holding device 20 using the displayed identifiers 12. In this way, the front panel 22a limits the visibility of a portion of the confidential information or identifiers 12 deterring the theft of the confidential information from a bystander or other.

In FIG. 4, the wallet card 10 is generally received within the card receiver 26 with the engaging member 40 associated with the surface of the wallet card 10 resisting lateral or horizontal movement of the wallet card 10 while the notch 50 limits longitudinal or vertical movement of the card 10 within the card receiver 26.

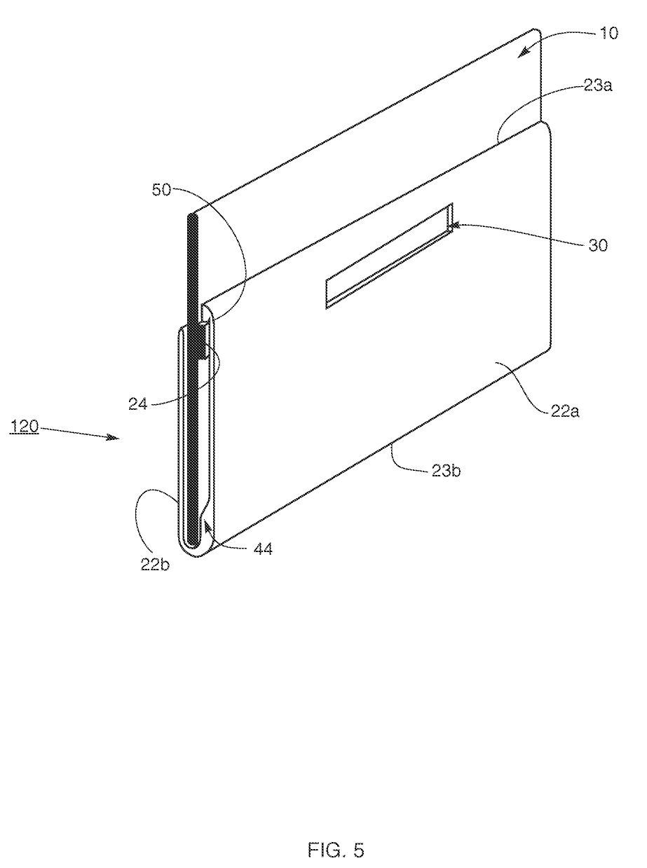

Alternatively, an optional lower biasing structure 44 may be utilized for positioning the identifier 12 within the configuration 30 and securing the surface of the wallet card 10 against the engaging member 40, in the alternative embodiment of the device 120 illustrated in FIGS. 5-8. The optional bottom biasing member 44 being generally adapted to align the card 10 within the card receiver 26 and to position the identifier 12 for display within the configuration 30.

Upon placing the card 10 within the card receiver 26, directing the card 10 past the engaging surface 40, downwardly along the front and rear panels 22a, 22b towards the bottom 23b the lower biasing member 44 may press against the bottom of the wallet card 10. By pressing against the bottom of the wallet card 10, the upper portion of the wallet card 10 having the identifier 12 is rotated towards the panel configuration 30 whereby the notch 50 engages the identifier 12. The rear panel 22b is illustrated with a shorter height than the front panel 22a, providing additional visibility of the rear surface of the wallet card 10, for example to review financial institution information or to verily the cardholders signature; however, the rear panel 22b may have other alternative configurations or shapes which may be adapted for use by the present wallet card holding device 120. Such alternative configurations may include providing a window (not shown) along the rear panel 22b to display portions of the wallet card 10, while concealing others.

If necessary, the wallet card 10 may be removed from the alternative wallet

card holding device 120, similar to removing the wallet card 10 from the wallet card holding device 20, by separating the notch 50 from the identifier 12 associated with the wallet card 10, spacing the panels 22a, 22b apart, the top 23a being generally rotated from the rear panel 22b, disengaging the notch 50 from the identifier 12. The wallet card 10 may then be removed from the wallet card holding device 120. Replacement of the wallet card 10 may be handled in a similar manner, by separating the front panel 22a from the rear panel 22b and inserting the wallet card 10 into the card receiver 26, the engaging member 40 positioned along the card surface 10 such that the notch 50 guides the identifier 12 for, at least partial, display within the panel configuration 30. The bottom 23b provides a memory structure for restoring the spacing between the first and second panels 22a, 22b, in relation to the lower biasing structure 44 for alignment of the identifier 12 within the panel configuration 30.

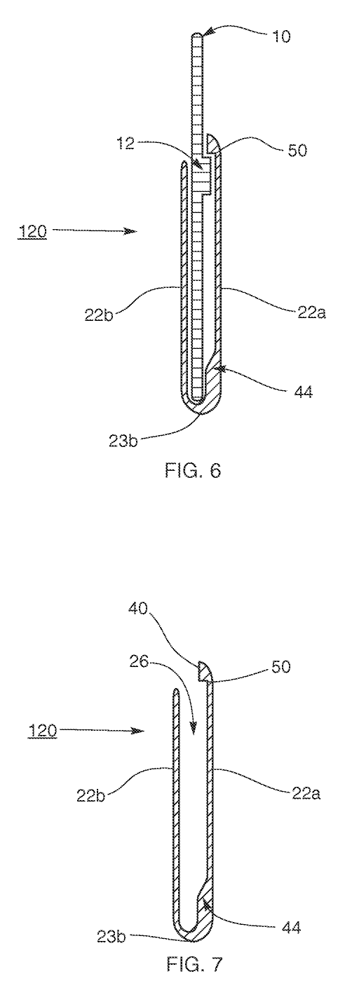

The cross section of the raised region presented by the elevated card identifier 12 is illustrated in FIG. 6, the notch 50 providing a guide for the identifier 12, which may be embossed characters, associated with the wallet card 10. The notch 50 generally limits vertical movement of the wallet card 10 within the card receiver 26. FIG. 7 illustrates the wallet card holding device 120, without the wallet card 10, the lower biasing structure 44 being generally associated with the front panel 22a and presenting an offset sloped surface terminating at the bottom 23b. The offset sloped surface associated with lower biasing structure 44 helps to direct the bottom of the wallet card 10 towards the bottom 23b as the wallet card 10 is inserted into the wallet card holding device 120 and maintains pressure against the bottom of the wallet card 10 during receipt within the card receiver 26.

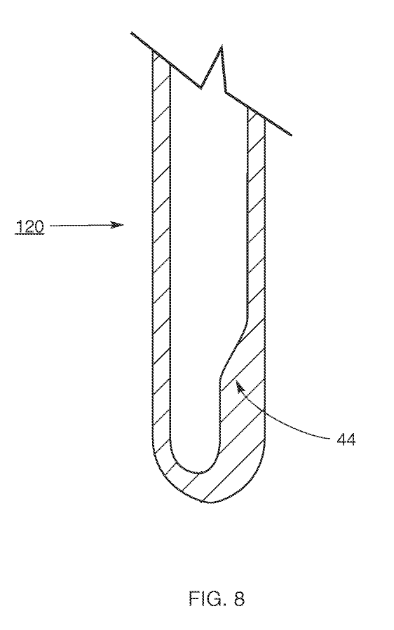

The bottom biasing member 44 can be seen in FIG. 8 with the biasing

member 44 including the offset sloped surface for directing the card 10 towards the rear panel 22b away from the front panel 22a generally causing the top 23a to rotate towards the front panel 22a for alignment of at least a portion of the identifier 12 within the configuration 30 associated with the front panel 22a.

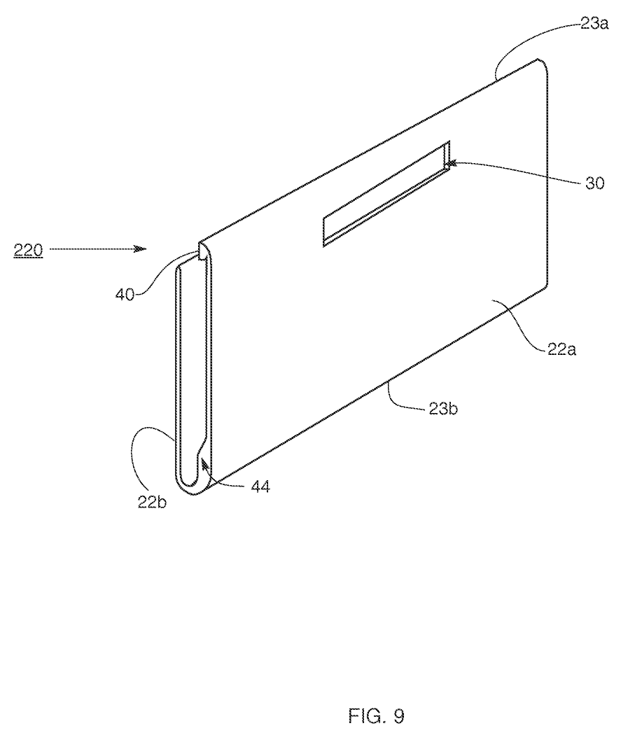

FIG. 9 illustrates an alternative embodiment of the wallet card holding

device 220, with the front panel 22a joined to the rear panel 22b along the bottom 23b, the card receiver 26a being spanning the front and rear panels along the bottom 23b. The wallet card 10 may be laterally aligned within the wallet card holding device 20 with the identifier 12 positioned within the configuration 30. Without a pair of sidewalls the alternative wallet card holding device 220 may be more easily compressed for fitting within a wallet compartment (not shown) for transportable storage by a user within a typical wallet (not shown). In addition, the alternative wallet card holding device 220 may provide for lateral removal of the wallet card 10 from the device 220 in which the engaging member may optionally have a more lasting connection.

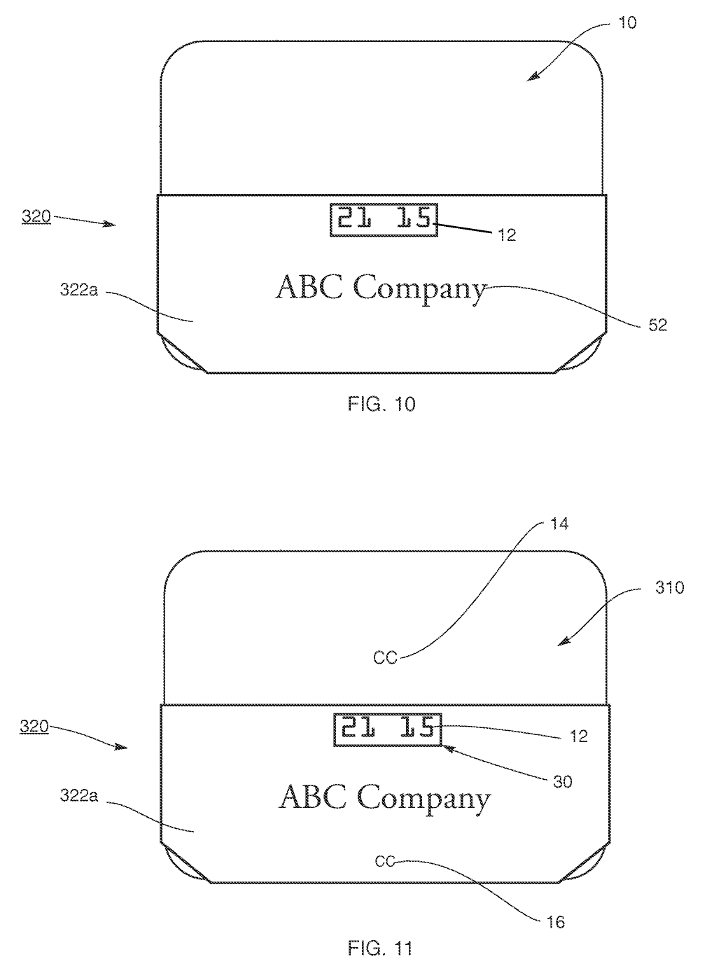

An alternative embodiment of the wallet card holding device is illustrated in FIGS. 10-13 with said front panel 322a and front panel 422a having an alternative frustoconical configuration, allowing the wallet card 10 to extend outwardly from the front panel corners. Alternatively, the rear panel or both the front and rear panel may have the frustoconical configuration for reducing the manufacturing costs and extending the card outwardly from the edges of the device improving removal from the alternative wallet card holding device. This may provide some cost savings by reducing the material and manufacturing costs necessary for producing the present invention.

FIGS. 10-11 also illustrate visual indicia 52, which may include advertising or other personalized content, positioned, along the front panel 322a. Indicia or emblems 52 may be used for various purposes including, but not limited to, advertising, indicating an affiliation, membership or other association or for such other uses as one may benefit from the display of visual indicia. The front panel 322a having a substantially flat, planar surface is generally adapted for receiving such indicia 52 which would allow the user to display the indicia 52 while protecting the confidential information associated with the wallet card 10. Because some wallet cards issued from certain financial institutions have a similar visual appearance, the customized indicia may also help differentiate plural wallet cards from each other. As an example, the indicia 52 may be printed on the front panel 322a or the indicia 52 may include an adhesive element affixed to the front panel 322a.

FIG. 11 illustrates an identifying element 16 located on the front panel 322a of the alternative wallet card holding device 320 at least one of which corresponds to an additional indicia 14 located on the alternative wallet card 310. Using the identifying element 16 which is complementary to or corresponds with the additional indicia 14 on the wallet card 310 provides another way to quickly verify the wallet card 310 located within the wallet card holding device 320 is the card 10 intended for use with the wallet card holding device 320. For example, if the device 320 in receipt of the card 310 is temporarily transferred to a third party during a consumer purchase transaction, when the device 320 is returned, the card's 310 additional indicia can be quickly verified by inspecting that the identifying element 16 located on the front panel 322a of the wallet card holding device 320 matches the additional indicia 14 contained on the card 310.

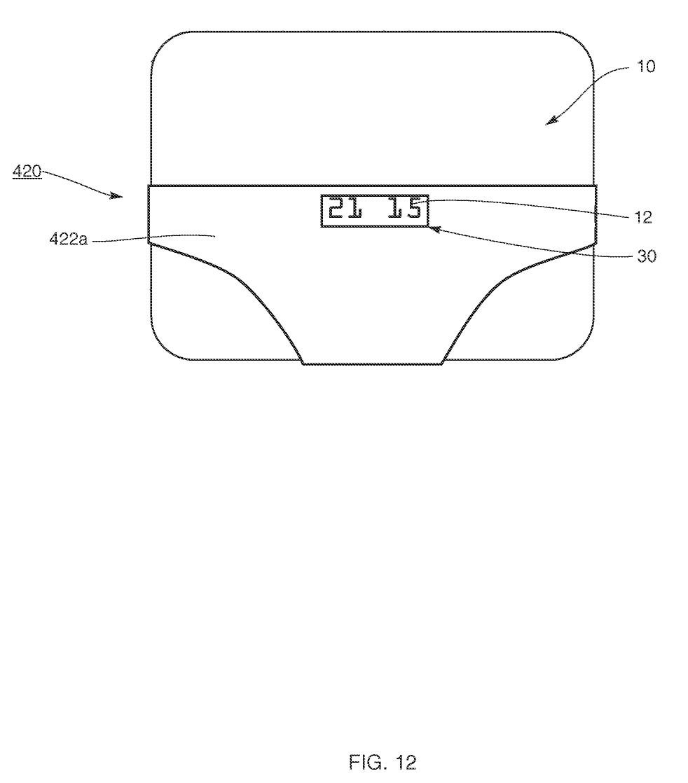

FIG. 12 illustrates an alternative embodiment of the wallet card holding device 420 which may be manufactured from plastic, metal, leather or some other generally thin material which may encircle the card 10 while providing a configuration 30 located on the front panel 422a for displaying a portion of the identifier 12. The wallet card holding device 420 may be configured into a variety of shapes both regular and irregular for receiving the card 10 between the front and rear panels 422a, 22b.

Using a wide variety of materials for the wallet card holding device 420 provides for a large number of alternative design configurations which are within the scope of the present invention. As an example, but not as a limitation, the wallet card holding device 420 is illustrated in FIG. 12 resembling an item of clothing such as a shirt, pant or undergarment, as desired by the user with the card 10 being generally received at the card receiver 26. An irregular shaped wallet card holding device may allow the user to display a variety of visual representations in connection with use of the card which may also stimulate conversation between nearby persons, enhancing the social interaction of the consumer while concealing the confidential information. Conversation directed towards the wallet card holding device 420 may generate additional interest in the use of the wallet card holding device 420 leading towards a wider network of consumers.

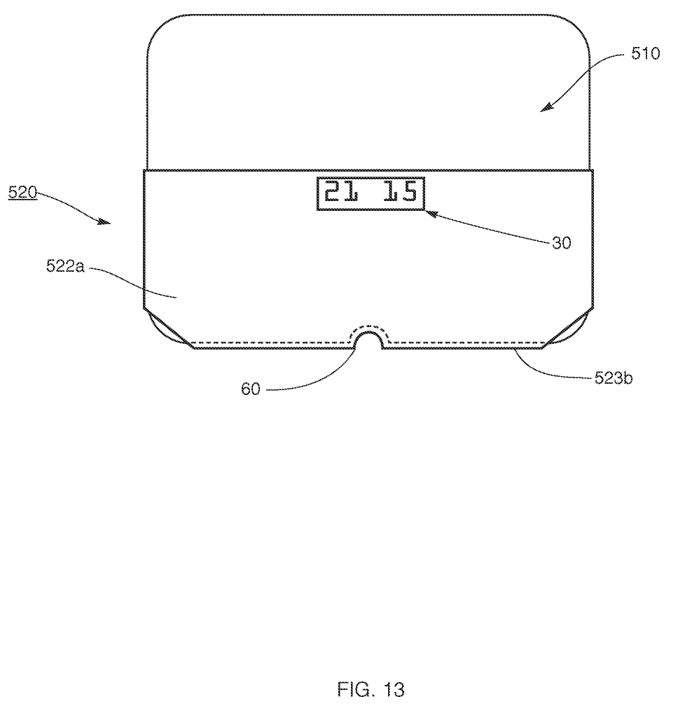

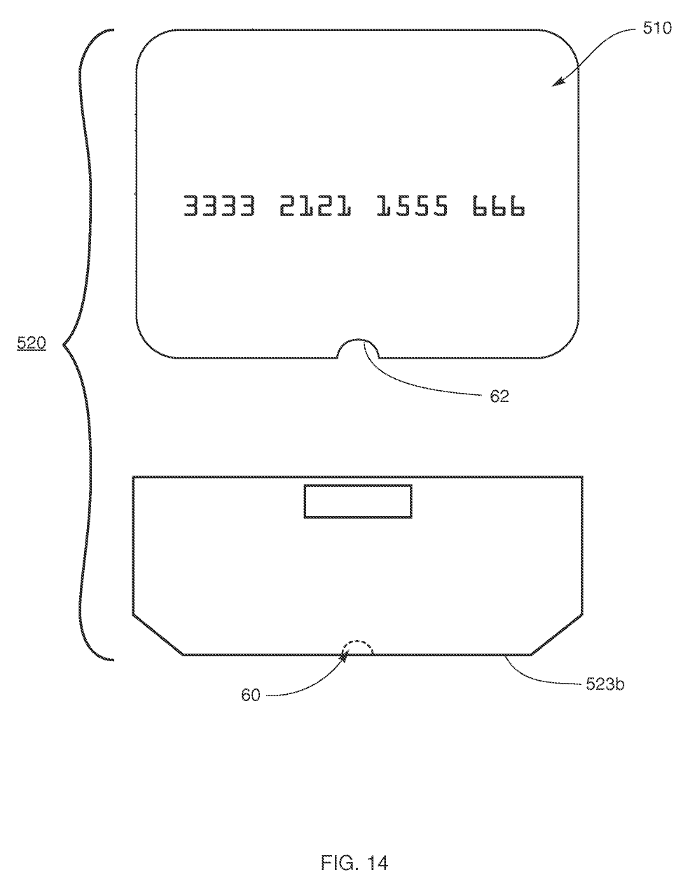

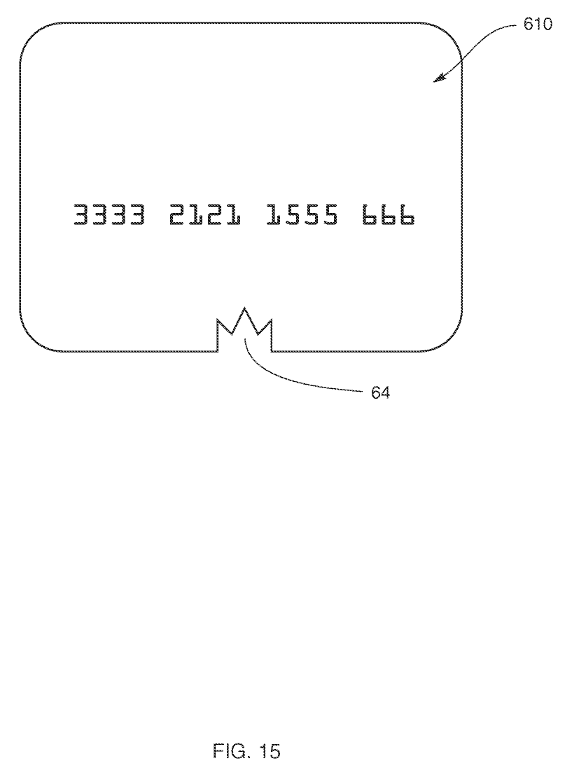

FIG. 13 illustrates an alternative embodiment 520 having an alignment structure 60 adapted for aligning the alternative wallet card 510 within the card receiver 26, the front panel 522a having an alignment structure 60 and a configuration 30 for displaying a portion of the identifier 12. As illustrated, the alignment structure 60 may be associated with the bottom 523b, extending from the front panel 522a to the rear panel (not shown). An impression 62 associated with the wallet card 510, having a complementary shape and adapted for receiving the alignment structure 60 may be utilized for aligning wallet card 510 within the card receiver 26, the identifiers 12 being properly positioned within the configuration 30. The alignment structure 60 may be helpful in detecting if another wallet card is substituted, for the wallet card 510 having the complementary impression 62. As illustrated in FIG. 14, the alignment structure 60 has a general arcuate shape adapted for receipt by the arcuate impression 62 located near the bottom of the wallet card 510. The wallet card 510 may be preconfigured with the desired impression 62, or a tool or cutting device may be used at a later time to modify the wallet card 510 with the desired impression 62. Alternatively as illustrated in FIG. 15, the alternative wallet card 610 may include an irregular impression 64 adapted for receipt by an irregular shaped alignment structure (not shown).

It will be appreciated that various other configurations and embodiments may fall within the scope of the present invention. While certain forms of the present invention have been illustrated and described herein, it is not to be limited to the specific forms or arrangement, of parts described and shown.

Having thus described the invention, what is claimed as new and desired to be secured by Letters Patent is:

1. A wallet, card holder device in combination with a wallet card having an identifier and an encoded strip, said wallet card holder device adapted for receipt of the wallet card, the wallet card identifier being partially covered by said device, said encoded, strip remaining uncovered, the wallet card, holder device further comprising:
a front panel associated with said wallet card, said front panel including an engaging member, limiting movement of said wallet card received within said wallet card, holder device, and
said front panel having a configuration adapted for displaying at least a portion of the identifier.

2. The combination of claim 1 further comprising a lower biasing structure adapted, for positioning said identifier within said configuration, said wallet card extending longitudinally from said lower biasing structure, along said, front panel and outwardly from said wallet card holder device whereby said encoded strip is accessible.

3. The combination of claim 2 wherein said lower biasing structure includes an offset sloped surface whereby said identifier is aligning within said configuration.

4. The combination of claim 1 wherein said wallet card holder device further comprises an identifying element corresponding to an additional indicia associated with said wallet card.

5. The combination of claim 1 further comprising a rear panel spaced from said front panel and associated with said encoded strip.

6. The combination of claim 5 wherein at least one of said front and rear panels has a frustoconical configuration.

7. The combination of claim 5 further comprising a pair of sidewalk extending between said front panel and said rear panel, said sidewalls enclosing said wallet card between said panels and said sidewalls, limiting lateral movement of said wallet card.

8. The combination of claim 5 further comprising;
a card receiver positioned between said front and rear panels adapted for receiving said wallet card, and
an alignment structure associated with said card receiver, said alignment structure corresponding to a preconfigured impression associated with said wallet card whereby said card having an impression corresponding to said, alignment structure is aligned within said, card receiver.

9. The combination of claim 8 wherein said alignment structure is arcuate corresponding to an arcuate impression associated with said, wallet card.

10. The combination of claim 8 wherein said alignment structure is irregular corresponding to an irregular impression associated with said wallet card.

11. The combination of claim 1 wherein said engaging member further comprises a frustropyramidal configuration for engaging said wallet card.

12. The combination of claim 1 further comprising:
a notch presented by said engaging member, and
said identifier comprises a plurality of embossed characters whereby said notch
receives said embossed characters as the card extends laterally along said front panel.

13. A wallet card holder device adapted for receiving a wallet card having an identifier and an encoded strip, the wallet card identifier being partially covered by said device, said encoded strip remaining uncovered, the wallet card holder further comprising:
a front panel associated with the wallet card, said front panel including an engaging member limiting longitudinal movement of the wallet card received within said device,
a rear panel spaced from said front panel and associated with and positioned below the encoded strip, said rear panel and said front panel defining a card receiver positioned therebetween and adapted for receiving said wallet card,
said front panel having a configuration for displaying a portion of the identifier, and
a lower biasing structure having an offset sloped surface and being adapted for aligning said identifier within said configuration, said wallet card extending longitudinally from said lower biasing structure, along said front panel and outwardly from said holder whereby the encoded strip is accessible.

14. The combination of claim 13 further comprising an alignment structure associated with said card receiver, said, alignment structure corresponding to a preconfigured impression associated with said wallet card whereby said card having an impression corresponding to said alignment structure is aligned within said card receiver

15. A method of protecting a wallet card having an identifier and an encoded strip comprising the steps of:
providing a wallet card holding device having a card receiver adapted for receiving the wallet card,
configuring a front panel of said wallet card holding device for displaying a portion of
the identifier,
applying the wallet card identifier to the wallet card,
positioning the wallet card within the wallet card holding device whereby at least a portion of the identifier is covered by the wallet card holding device and a substantial portion of the encoded strip remains uncovered, and
securing the received wallet card at said identifier with an engaging member associated with said front panel.

16. The method of claim 15 wherein the step of positioning further includes aligning said identifier at said front panel with a lower biasing structure whereby at least a portion of said identifier is displayed by said configured front panel.
